(19) United States
(12) Patent Application Publication
(10) Pub. No.: US 2025/0353945 A1
(43) Pub. Date: Nov. 20, 2025

(54) REACTIVE RESINS BASED ON ETHYL METHACRYLATE

(71) Applicant: Röhm GmbH, Darmstadt (DE)

(72) Inventors: Alexander Klein, Gau-Algesheim (DE); Janos Lotz, Gelnhausen (DE)

(73) Assignee: Röhm GmbH, Darmstadt (DE)

(21) Appl. No.: 18/873,361

(22) PCT Filed: Jun. 7, 2023
(86) PCT No.: PCT/EP2023/065163

§ 371 Date: Dec. 10, 2024

(30) Foreign Application Priority Data
Jun. 10, 2022 (EP) 22178286.5

(51) Int. Cl. C08F 265/06; C08K 5/18

(52) U.S. Cl. CPC C08F 265/06; C08K 5/18

(57) ABSTRACT

A reactive resin has at least ethyl methacrylate, a prepolymer having an acid value in the range from 1 to 12 mg (KOH)/g, and optionally also either an initiator or an accelerator. In addition, a 2K system has the reactive resin and a curing agent component, and the 2K system finds application as a road marking, road repair compound, intumescent coating, floor coating, casting resin, building protection, membrane, waterproofing, coating compound and/or laminating composition.

### FIELD OF THE INVENTION

The present invention relates to a reactive resin containing at least ethyl methacrylate, a prepolymer having an acid value in the range from 1 to 12 mg (KOH)/g, and optionally also either an initiator or an accelerator. In addition, the invention relates to a 2K system comprising the reactive resin according to the invention and a curing agent component, and to the use of the 2K system as a road marking, road repair compound, intumescent coating, floor coating, casting resin, building protection, membrane, waterproofing, coating compound and/or laminating composition.

### PRIOR ART

Reactive resins and 2K systems that contain them are known per se. Decreasing the volatile constituents of a reactive resin and thus the exposure of users and the odor nuisance during use thereof has long been a goal of development. Reactive resins of this kind are described in various prior art documents.

EP 2 739 677 B1 relates to an odor-free (meth)acrylic reactive resin that contains high-boiling reactive (meth)acrylic monomers from the group of polar cyclic substituted esters. These are used as a substitute for methyl (meth)acrylate (MMA). Although these resins can be cured tack-free under laboratory conditions, the inadequate re-formation of the paraffin film in the event of subsequent disturbance of the film within the pot life after first application of a coating has proven problematic in practice. The limited pot life means for example that fresh coatings must normally be repeatedly applied on coatings previously applied. In this case it is necessary, for the purpose of equalization, for the previously applied coating to be rollered again with the freshly prepared coating some minutes after application. This results in destruction of the paraffin film that had initially formed, which must form again completely in order to permit tack-free curing of the coating at the surface. This is not always guaranteed with reactive resins based on the described high-boiling reactive (meth)acrylic monomers. In particular, coatings covering large areas sometimes as a result have defects that tend to pick up dirt and make it easier for the coating to be attacked by media, which can in turn give rise to defects in the overcoating, with the result that such resins can be used only to a very limited extent in practice.

US 2019/0264042 A1 discloses cold-curing reactive resin formulations for (meth) acrylate-based floor coatings, in particular ones based on methyl (meth)acrylate that include an odorant to improve the odor. However, the level of emissions of volatile components, in particular emissions of methyl (meth)acrylate, remains unchanged during application and the odor is merely masked.

WO 2016/026757 A1 discloses a dirt-repelling reactive-resin sealant for marking or coating floor surfaces or roadways, such as roads, on a cold plastic basis. This sealant reduces dirt adhesion, especially in hot and/or dry, dusty environments. This means that the markings remain more easily visible than conventional markings, even in dry, hot regions. A disadvantage of the described method is the additional work involved in applying two marking layers.

WO 2011/006767 A1 discloses formulations for the marking of roadways, such as roads, that after application can be driven on again after a shortened wait time. The examples describe the use of polymers having an acid function. A disadvantage of the disclosed reactive resins is the high proportion of crosslinkers, which results in the road markings having only low flexibility and also a tendency to become brittle and to chip, especially when applied in thicker layers.

WO 2013/185993 A1 discloses formulations (reactive resins) for the marking or coating of floor surfaces or roadways, for example roads. The formulations are less harmful to health and have good mechanical properties. In particular, fast-curing reactive resins having a low content of accelerating amines are to be provided. The document relates in particular to reactive resins containing asymmetric aromatic tertiary amines as an accelerator component. A disadvantage of the disclosed reactive resins is the exclusive focus on the health hazards due to the accelerating amine component and on the efficiency of said component in the resins with other use properties unchanged, i.e. with dirt pick-up in particular unchanged. Measures to reduce the health hazards for users due to exposure to volatile components such as methyl (meth)acrylate or due to the use of phthalate-containing peroxides are not described.

CN 105 753 367 A describes a resin-containing composition for bridge repairs. The resin contains two different types of monomer, prepolymers, and an initiator. A prepolymer having an acid value of 1 to 12 mg (KOH)/g is not disclosed.

CN 111 005 287 A describes a method for repairing roads. This method employs a surface repair material that contains acrylate monomers, an acrylic resin polymer, silanes, fillers, an accelerator, and a polymerization inhibitor. A prepolymer having an acid value of 1 to 12 mg (KOH)/g is not disclosed. EP 2 979 851 A1 relates to a process for producing composite semifinished products and the further processing thereof into moldings. In this process, a fibrous support is impregnated with a resin composition that contains inter alia monomers and prepolymers. A prepolymer having an acid value of 1 to 12 mg (KOH)/g is not disclosed.

US 2017/0029563 A1 discloses a coating system containing a (meth)acrylic monomer and a reactive polymer, oligomer or prepolymer having acrylate or methacrylate groups. A prepolymer having an acid value of 1 to 12 mg (KOH)/g is not disclosed.

Some of the reactive resins described in the prior art already have good odor properties. However, they often have disadvantages in their processing and/or in their tendency to pick up dirt. Moreover, they often do not provide a solution for decreasing the emissions of monomers, but merely mask the odor thereof through the addition of fragrances.

### Object

There was therefore a need for alternative reactive resins and 2K systems that do not have the disadvantages of the reactive resins and 2K systems described in the prior art or have them only to a lesser extent. In particular, the alternative reactive resins and 2K systems should have decreased emissions of organic components when being worked with. In addition, the 2K system should be particularly suitable for use as road markings and floor coatings, especially ones having decreased dirt pick-up.

### Achievement of Object

This object was achieved by a reactive resin containing the following components:
5% to 94% by weight of ethyl methacrylate,
5% to 50% by weight of at least one prepolymer having an acid value in the range from 1 to 5% to 50% by weight 12 mg (KOH)/g,
0% to 50% by weight of at least one oligomer,
0% to 30% by weight of at least one crosslinker,
0% to 80% by weight of at least one comonomer,
and optionally either 0.1% to 10% by weight of at least one initiator or 0.1% to 5% by weight of at least one accelerator,
in each case based on the total weight of the reactive resin.

This object was further achieved by a 2K system comprising the following components:
a reactive resin as claimed in any of claims 1 to 12 and
a curing agent component that contains either 0.1% to 10% by weight of at least one initiator or 0.1% to 5% by weight of at least one accelerator, in each case based on the total weight of the reactive resin, wherein
either the reactive resin contains the at least one initiator and the curing agent component contains the at least one accelerator or the reactive resin contains the at least one accelerator and the curing agent component contains the at least one initiator.

It was surprisingly found that 2K systems containing the reactive resins of the invention cure tack-free even at low ambient temperatures and in contact with atmospheric oxygen. They also have particularly low dirt pick-up on their surface, especially when used for producing road markings and/or floor coatings. The particularly low dirt pick-up is due in particular to the use of ethyl methacrylate in combination with a prepolymer having an acid value in the range from 1 to 12 mg (KOH)/g.

In addition, the reactive resin and the 2K system can be applied with decreased emissions, in particular reduced monomer emissions. This is particularly the case when, in a particularly preferred embodiment of the invention, the reactive resins are essentially free of methyl (meth)acrylate . The use in particular of phthalate-free curing agents for processing the novel 2K systems makes it possible for health risks to be reduced further. This represents a further particularly preferred embodiment. The reactive resin and 2K system of the invention have a sufficiently long processing time for manual surface uses, in particular as a road marking, road repair compound, intumescent coating, floor coating, casting resin, building protection, waterproofing, membrane, coating compound and/or laminating composition. The reactive resin and/or the 2K system can accordingly be overcoated or rollered over multiple times with processing tools for equalization and/or forming of the surface, without this causing curing disturbances at the surface. The reactive resin, in particular the reactive resin, which is essentially free of methyl (meth)acrylate , also makes it possible to formulate coating and marking compounds (2K systems) that have a higher flash point compared to reactive resins containing methyl (meth)acrylate . They are therefore less flammable. The reactive resins also have increased flexibility and reduced shrinkage, which improves their impact resistance and reduces crack formation in coatings produced therefrom. They also have lower water absorption. Together with the increased flexibility, this offers advantages when using the 2K system as an intumescent coating and as corrosion protection.

The reactive resin according to the invention is described more particularly below.

A reactive resin is understood in the context of the present invention as meaning a mixture of at least one monomer and at least one prepolymer that can be readily cured when used as a 2K system.

According to the invention, the reactive resin contains the following components:
5% to 94% by weight, preferably 10% to 70% by weight, of ethyl methacrylate,
5% to 50% by weight, preferably 10% to 40% by weight, of at least one prepolymer having an acid value in the range from 1 to 12 mg (KOH)/g,
0% to 50% by weight of at least one oligomer,
0% to 30% by weight, preferably 0.1% to 15% by weight, of at least one crosslinker,
0% to 80% by weight, preferably 0% to 40% by weight, of at least one comonomer,
and optionally either 0.1% to 10% by weight, preferably 1% to 5% by weight, of at least one initiator, or 0.1% to 5% by weight, preferably 0.5% to 3% by weight, of at least one accelerator,
in each case based on the total weight of the reactive resin.

Preference is therefore also given to a reactive resin wherein the reactive resin contains the following components:
10% to 70% by weight of ethyl methacrylate,
10% to 40% by weight of at least one prepolymer having an acid value in the range from 1 to 12 mg (KOH)/g,
0% to 50% by weight of at least one oligomer,
0.1% to 15% by weight of at least one crosslinker,
0% to 40% by weight of at least one comonomer,
and optionally either 1% to 5% by weight of at least one initiator or 0.5% to 3% by weight of at least one accelerator,
in each case based on the total weight of the reactive resin.

It will be apparent that all % by weight data refer to % by weight before the components have reacted together. During the reaction, the weight ratios of the components may change. This is known per se to those skilled in the art.

Preferably, the % by weight of the ethyl methacrylate, of the at least one prepolymer, of the at least one oligomer, of the at least one crosslinker, of the at least one comonomer, and optionally of the at least one initiator and of the at least one accelerator add to up to 100% by weight. It is therefore preferable that the reactive resin consists of these components.

According to the invention, the reactive resin contains 5% to 94% by weight, preferably 10% to 70% by weight, of ethyl methacrylate, based on the total weight of the reactive resin. Ethyl methacrylate is known per se and is also referred to as methacrylic acid ethyl ester or EMA.

The reactive resin contains 5% to 50% by weight, preferably 10% to 40% by weight, based on the total weight of the reactive resin, of at least one prepolymer having an acid value in the range from 1 to 12 mg (KOH)/g.

The prepolymer preferably has an acid value in the range from 3 to 10 mg (KOH)/g. The acid value is in accordance with the invention determined according to DIN EN ISO 2114.2002 Plastics (polyesters) and coating materials (binders)—Determination of partial acid value and total acid value.

What is meant by the term “at least one prepolymer” in the context of the present invention is either exactly one prepolymer or a mixture of two or more prepolymers. A “prepolymer” for the purposes of the present invention has a weight-average molecular weight in the range from 25 000 g/mol to 80 000 g/mol, preferably in the range from 30 000 g/mol to 70 000 g/mol, determined by GPC (gel-permeation chromatography) with PMMA as standard.

Preference is therefore also given to a reactive resin in which the at least one prepolymer has a weight-average molecular weight in the range from 25 000 g/mol to 80 000 g/mol.

The at least one prepolymer can be used for example to improve the polymerization properties, the mechanical properties, the adhesion to the substrate, and also the optical properties of the reactive resin and 2K systems produced therefrom.

Suitable prepolymers are selected for example from the group consisting of polyesters, poly(meth)acrylates, polyvinyl acetates, polyvinyl chlorides, polystyrene, and copolymers thereof. Preferably, the at least one prepolymer is selected from the group consisting of polyesters and poly(meth)acrylates.

Preference is therefore also given to a reactive resin in which the at least one prepolymer is selected from the group consisting of polyesters and poly(meth)acrylates.

“Polyalkyl(meth)acrylates” in the context of the present invention are understood as meaning polymers and copolymers of alkyl (meth)acrylates. “Alkyl (meth)acrylates” are understood as meaning both alkyl acrylates and alkyl methacrylates. Preference is given to C₁-C₁₈-alkyl (meth)acrylates. “C₁-C₁₈-alkyl (meth)acrylates” are understood as meaning alkyl esters of (meth)acrylic acid having 1 to 18 carbon atoms in the alkyl radical. The alkyl radical may be linear, cyclic and/or branched. It may also include aromatic radicals and/or heteroatoms. For example, alkyl (meth)acrylates of the invention, the polymers or copolymers of which are polyalkyl(meth)acrylates of the invention, are selected from the group consisting of methyl (meth)acrylate , ethyl (meth)acrylate , propyl (meth)acrylate , n-butyl (meth)acrylate , isobutyl (meth)acrylate , 2-ethylhexyl (meth)acrylate , isopentyl (meth)acrylate , stearyl (meth)acrylate , benzyl (meth)acrylate , and lauryl (meth)acrylate .

The term “(meth)acrylic acid” in the context of the present invention encompasses both acrylic acid and methacrylic acid.

Polyalkyl(meth)acrylates may be produced by methods known to the skilled in the art, for example by solution polymerization, emulsion polymerization, suspension polymerization, bulk polymerization and/or precipitation polymerization.

Suitable polyesters are known per se and are preferably obtainable via polycondensation or ring-opening polymerization.

Polyesters and polyalkyl(meth)acrylates that may be employed as the at least one prepolymer may both have additional functional groups such as double bonds, for example for bonding or copolymerization. Preferably, the prepolymers do not have any double bonds.

The reactive resin contains 0% to 50% by weight of at least one oligomer based on the total weight of the reactive resin.

“At least one oligomer” in the context of the present invention is understood as meaning either exactly one oligomer or a mixture of two or more different oligomers. An oligomer is for the purposes of the present invention understood as meaning a macromolecule that is formed from a plurality of structurally identical or similar units.

The at least one oligomer is different from the at least one prepolymer.

The at least one oligomer of the invention has for example a weight-average molecular weight in the range from >1000 g/mol to <25 000 g/mol, preferably in the range from 1500 g/mol to 20 000 g/mol, determined by GPC (gel-permeation chromatography) with polyethylene glycol (PEG) as standard.

Preference is therefore also given to a reactive resin in which the at least one oligomer has a weight-average molecular weight in the range from >1000 g/mol to <25 000 g/mol.

The at least one oligomer is for example selected from the group consisting of polyurethane (meth)acrylates, polyethers, and polyesters. Polyethers are known per se and are selected for example from the group consisting of polyethylene glycol, polypropylene glycol, and polytetrahydrofuran.

Preferably, the at least one oligomer is therefore selected from the group consisting of polyurethane (meth)acrylates, polyethylene glycol, polypropylene glycol, and polytetrahydrofuran.

Preference is therefore also given in accordance with the invention to a reactive resin in which the at least one oligomer is selected from the group consisting of polyurethane (meth)acrylates, polyethylene glycol, polypropylene glycol, and polytetrahydrofuran.

“Polyurethane (meth)acrylates” in the context of the present invention are understood as meaning (meth)acrylates joined to one another via urethane groups. They are obtainable by reaction of hydroxyalkyl (meth)acrylates with polyisocyanates and polyoxyalkylenes having at least two hydroxy functionalities. Instead of hydroxyalkyl (meth)acrylates, it is also possible to use esters of (meth)acrylic acid with oxiranes, for example ethylene oxide or propylene oxide and corresponding oligooxiranes or polyoxiranes. Suitable polyurethane (meth)acrylates are known per se. An overview by way of example of urethane (meth)acrylates having a functionality of greater than two is given in DE 199 02 685. Commercially available examples produced from polyols, isocyanates, and hydroxy-functional (meth)acrylates are available under the Ebecryl trade name from Allnex, for example Ebecryl 210 and Ebecryl 230.

Polyurethane (meth)acrylates increase the flexibility, breaking strength, and elongation at break of a reactive resin without any relatively major temperature dependence. This increases the temperature stability of, for example, a road marking produced from the reactive resin. Embrittlement caused by a higher crosslinker content can be compensated and adhesion to the road surface can be compensated.

The reactive resin contains 0% to 30% by weight, preferably 0.1% to 15% by weight, of at least one crosslinker, based on the total weight of the reactive resin.

What is meant by “at least one crosslinker” in the context of the present invention is either exactly one crosslinker or a mixture of two or more crosslinkers.

A crosslinker in the context of the present invention is understood as meaning a compound that can connect together two or more prepolymers and/or polymers formed from ethyl methacrylate. A crosslinker has at least two functional groups capable of reacting with the at least one prepolymer and/or the ethyl methacrylate.

It will be apparent that the at least one crosslinker is different from the at least one oligomer.

For example, the at least one crosslinker is selected from the group consisting of difunctional, trifunctional, tetrafunctional, pentafunctional, and hexafunctional (meth)acrylates. The at least one crosslinker is particularly preferably selected from the group consisting of difunctional and trifunctional (meth)acrylates.

Preference is therefore also given to a reactive resin in which the at least one crosslinker is selected from the group consisting of difunctional, trifunctional, tetrafunctional, pentafunctional, and hexafunctional (meth)acrylates

Such crosslinkers are known per se, for example allyl (meth)acrylate , butane-1,4-diol di(meth)acrylate , poly(urethane)(meth)acrylate , tetraethylene glycol di(meth)acrylate , triethylene glycol di(meth)acrylate and/or trimethylolpropane tri(meth)acrylate . Suitable crosslinkers are for example available under the Ebecryl 140 and Ebecryl 895 trade names from Allnex.

For example, the at least one crosslinker has a molecular weight in the range from 150 g/mol to 1000 g/mol, preferably in the range from 170 g/mol to 800 g/mol.

Preference is therefore also given to a reactive resin in which the at least one crosslinker has a molecular weight in the range from 150 g/mol to 1000 g/mol.

The reactive resin contains 0% to 80% by weight, preferably 0% to 40% by weight, of at least one comonomer, based on the total weight of the reactive resin.

What is meant by “at least one comonomer” in the context of the present invention is either exactly one comonomer or a mixture of two or more comonomers.

It will be apparent that the at least one comonomer is different from ethyl methacrylate. Likewise, the at least one comonomer is different from the at least one crosslinker and the at least one oligomer.

All compounds that can be copolymerized with ethyl methacrylate are suitable as the at least one comonomer. For example, the at least one comonomer selected from the group consisting of C₃-C₁₈-alkyl (meth)acrylates, C₁-C₂-alkoxy (meth)acrylates, (meth)acrylic acid, itaconic acid, (meth) acrylamides, 1-alkenes, and styrene.

Preference is therefore also given in accordance with the invention to a reactive resin in which the at least one comonomer is selected from the group consisting of C₃-C₁₈-alkyl (meth)acrylates, C₁-C₂-alkoxy (meth)acrylate , (meth)acrylic acid, itaconic acid, (meth)acrylamide, 1-alkenes, and styrene.

“C₃-C₁₈-alkyl (meth)acrylate ” in the context of the present invention is understood as meaning alky! esters of (meth)acrylic acid having 3 to 18 carbon atoms in the alkyl radical. The alkyl radical may be linear, cyclic or branched. The alkyl radical may also contain aromatics. C₃-C₁₈-alkyl (meth)acrylates that contain aromatics in the alkyl radical include for example benzyl (meth)acrylate . In addition, the alkyl radical may contain heteroatoms. C₃-C₁₈-alkyl (meth)acrylates in which the alkyl radical contains heteroatoms include for example hydroxy-functionalized C₃-C₁₈-alkyl (meth)acrylates, such as hydroxypropyl (meth)acrylate , and reaction products thereof with lactones, such as hydroxyethylcaprolactone (meth)acrylates, and also ether (meth)acrylates, such as ethylene glycol (meth)acrylate .

Preference is therefore given to a C₃-C₁₈-alkyl (meth)acrylateselected from the group consisting of benzyl (meth)acrylate , hydroxypropyl (meth)acrylate , hydroxyethylcaprolactone (meth)acrylate , propyl (meth)acrylate , n-butyl (meth)acrylate , isobutyl (meth)acrylate , n-octyl (meth)acrylate , 2-octyl (meth)acrylate , 2-ethylhexyl (meth)acrylate , isopentyl (meth)acrylate , stearyl (meth)acrylate , and lauryl (meth)acrylate .

“C₁-C₂-alkoxy (meth)acrylate ” in the context of the present invention is understood as meaning an alkyl ester of (meth)acrylic acid having 1 to 2 carbon atoms and at least one oxygen atom in the alkyl radical. C₁-C₂-alkoxy (meth)acrylates include for the purposes of the present invention, for example, ethylene glycol (meth)acrylate and hydroxyethyl (meth)acrylate .

The term “(meth)acrylic acid” in the context of the present invention encompasses, as already set out above, both acrylic acid and methacrylic acid.

Itaconic acid is known per se and is also referred to as methylidenesuccinic acid.

The term “(meth)acrylamide” is understood as meaning both acrylamide and methacrylamide.

Suitable 1-alkene comonomers are known per se, for example 1-hexene, 1-heptene, vinylcyclohexane, 3.3-dimethyl-1-propene, 3-methyl-1-diisobutylene, and 4-methyl-1-pentene.

The term “styrene” in the context of the present invention is understood as meaning not just styrene per se but also substituted styrenes, for example α-methylstyrene, α-ethylstyrene, vinyltoluene, p-methylstyrene, styrenesulfonic acid, monochlorostyrenes, dichlorostyrenes, and tribromostyrenes, preference being given to a-methylstyrene, a-ethylstyrene, vinyltoluene, p-methylstyrene, and styrenesulfonic acid.

Preferably, the at least one copolymer does not comprise methyl (meth)acrylate . Particularly preferably, the reactive resin is essentially free of methyl (meth)acrylate .

Preference is therefore also given to a reactive resin that is essentially free of methyl (meth)acrylate .

“Essentially free of methyl (meth)acrylate ” in the context of the present invention is understood as meaning that the reactive resin contains not more than 2% by weight, preferably not more than 1% by weight, and particularly preferably not more than 0.1% by weight, of methyl (meth)acrylate , based on the total weight of the reactive resin. It is further preferable that any methyl (meth)acrylate present in the reactive resin originates exclusively from impurities in the components of the reactive resin, for example residual monomers present in the at least one prepolymer and/or in the at least one oligomer. Any methyl (meth)acrylate present in the reactive resin may in addition originate from cross-contamination during production of the reactive resin.

The reactive resin optionally contains either at least one initiator or at least one accelerator. In one embodiment of the present invention, the reactive resin does not contain an initiator or an accelerator.

In the context of the present invention, what is meant by “either at least one initiator or at least one accelerator” is that the reactive resin preferably contains just the at least one initiator and no accelerator or that the reactive resin contains just the at least one accelerator and no initiator.

The reactive resin preferably contains just the accelerator. It is thus preferable that the reactive resin does not contain an initiator.

The reactive resin may contain 0.1% to 10% by weight, preferably 1% to 5% by weight, of at least one initiator, in each case based on the total weight of the reactive resin.

What is meant by “at least one initiator” in the context of the present invention is either exactly one initiator or a mixture of two or more initiators. Exactly one initiator is preferred.

Suitable as the at least one initiator is any compound known to those skilled in the art that is capable of initiating free-radical polymerization of ethyl methacrylate. For example, the at least one initiator is selected from the group consisting of peroxides, azo compounds, and persulfates.

Preference is therefore also given in accordance with the invention to a reactive resin in which the at least one initiator is selected from the group consisting of peroxides, azo compounds, and persulfates.

Suitable peroxides are selected for example from the group consisting of hydrogen peroxide, dibenzoyl peroxide, dicyclohexyl peroxodicarbonate, dilauroyl peroxide, methyl ethyl ketone peroxide, acetylacetone peroxide, di-tert-butyl peroxide, tert-butyl hydroperoxide, cumene hydroperoxide, tert-butyl peroctanoate, tert-butyl per-2-ethylhexanoate, tert-butyl perneodecanoate, tert-butyl peroxymaleate, tert-amyl perpivalate, tert-butyl perpivalate, tert-butyl perbenzoate, di (tert-amyl) peroxide (DTAP), tert-butyl peroxy (2-ethylhexyl) carbonate (TBPEHC), dicumyl peroxide, diisopropyl peroxydicarbonate, and bis (4-t-butylcyclohexyl) peroxydicarbonate.

Suitable azo compounds are selected for example from the group consisting of 2,2-azobisiso-2,4-dimethylvaleronitrile, 2,2-azobisisobutyronitrile, 2,2′-azobis (2-amidinopropane) dihydrochloride, 2-(carbamoylazo)isobutyronitrile, and 4,4′-azobis (cyanovaleric acid).

Suitable persulfates are selected for example from the group consisting of lithium peroxodisulfate, sodium peroxodisulfate, potassium peroxodisulfate, and ammonium peroxodisulfate.

Preferably, the initiator does not contain phthalates. Particularly preferably, the reactive resin does not contain phthalates. It is thus preferable that the reactive resin is free of phthalates.

As set out above, the reactive resin in a preferred embodiment of the present invention does not contain an initiator.

The reactive resin may contain 0.1% to 5% by weight, preferably 0.5% to 3% by weight, of at least one accelerator, in each case based on the total weight of the reactive resin.

What is meant by “at least one accelerator” in the context of the present invention is either exactly one accelerator or a mixture of two or more accelerators. Exactly one accelerator is preferred in accordance with the invention.

The at least one accelerator used may be compounds known to those skilled in the art that accelerate the curing of the reactive resin. Suitable accelerators are for example tertiary aromatically substituted amines and/or phosphites. Preferably, the at least one accelerator is selected from the group consisting of tertiary aromatically substituted amines.

Preference is therefore also given in accordance with the invention to a reactive resin in which the at least one accelerator is selected from the group consisting of tertiary aromatically substituted amines.

The term “tertiary aromatically substituted amines” encompasses both symmetric tertiary aromatically substituted amines and asymmetric tertiary aromatically substituted amines.

Suitable symmetric tertiary aromatically substituted amines are selected for example from the group consisting of N,N-dimethyl-p-toluidine, N,N-dimethylaniline, N,N-diethylaniline, overethoxylated N, N-dihydroxyethyl-p-toluidine, overpropoxylated N,N-dihydroxypropyl-p-toluidine, N,N-bis(2-hydroxyethyl)-p-toluidine, and N,N-bis(2-hydroxypropyl)-p-toluidine.

Suitable asymmetric tertiary aromatically substituted amines are selected for example from the group consisting of N-methyl-N-(hydroxyethyl)-p-toluidine, N-methyl-N-(hydroxyethyl)-m-toluidine, N-methyl-N-(hydroxypropyl)-p-toluidine, an N-methyl-N-(hydroxyethyl) xylidine, an N-methyl-N-(hydroxypropyl)xylidine, N-methyl-N-(hydroxyethyl)aniline, and N-methyl-N-(hydroxypropyl)aniline.

Suitable phosphites are selected for example from the group consisting of tri-2-ethylhexyl phosphite, tri-2-ethylhexyl trithiophosphite, triisooctyl phosphite, triisooctyl trithiophosphite, tridecyl phosphite, tridecyl trithiophosphite, trilauryl phosphite, trilauryl trithiophosphite, trioctadecyl phosphite, trioctadecyl trithiophosphite, phenyl didecyl phosphite, phenyl didecyl trithiophosphite, phenyl dilauryl phosphite, phenyl distearyl phosphite, phenyl distearyl trithiophosphites, diphenyl decyl phosphite, diphenyl lauryl phosphite, diphenyl stearyl phosphite, diphenyl stearyl trithiophosphite, tri-para-cresyl phosphite, tri-meta-cresyl phosphite, tri-ortho-cresyl phosphite, tri-para-cresyl dithiophosphite, tri-para-octylphenyl trithiophosphite, tri-ortho-octylphenyl phosphite, tris (dipropylene glycol) phosphite, triethoxyethyl phosphite, tributoxyethyl phosphite, tritetrahydrofurfuryl phosphite, tritetrahydrofurfuryl trithiophosphite, triisodecyl phosphite, triphenylethyl phosphite, S-phenyl dilauryl monothiophosphite, S-phenyl didecyl monothiophosphite, S,S-diphenyl lauryl dithiophosphite, S,S-diphenyl decyl dithiophosphite, tri-ortho-naphthyl phosphite, S,S-diphenyl decyl dithiophosphite, phenyl dilauryl trithiophosphite, tridodecylphenyl phosphite, trichlorophenyl phosphite, diphenyl lauryl trithiophosphite, S-lauryl diphenyl monothiophosphite, tri-p-methoxyphenyl phosphite, S,O-diphenyl S-lauryl dithiophosphite, tri-o-methoxyphenyl dithiophosphite, S,S-dilauryl phenyl dithiophosphite, and S,O-dilauryl S-phenyl dithiophosphite.

On the basis of the reactive resins according to the invention, cold plastics can be produced from two or three components. Preference is given to cold plastics composed of two components, which are referred to as 2K systems. Cold plastics composed of three components are also referred to as 3K systems.

According to the invention, a 2K system comprises the following components:
A reactive resin according to the invention and
a curing agent component that comprises either 0.1% to 10% by weight of at least one initiator or 0.1% to 5% by weight of at least one accelerator, in each case based on the total weight of the reactive resin, wherein
either the reactive resin contains the at least one initiator and the curing agent component contains the at least one accelerator or
the reactive resin contains the at least one accelerator and the curing agent component contains the at least one initiator.

If the reactive resin is part of a 2K system, the reactive resin usually contains either the at least one initiator or the at least one accelerator.

For the reactive resin present in the 2K system, the statements and preferences previously described for the reactive resin according to the invention apply mutatis mutandis.

The curing agent component, when mixed with the reactive resin, initiates and/or accelerates the polymerization of at least the ethyl methacrylate present in the reactive resin.

The curing agent component therefore contains either the at least one initiator or the at least one accelerator. Typically, the curing agent component contains the at least one accelerator when the reactive resin contains the at least one initiator. The curing agent component contains the at least one initiator when the reactive resin contains the at least one accelerator

The curing agent component contains for example 0.1% to 10% by weight, preferably 1% to 5% by weight, of at least one initiator, in each case based on the total weight of the reactive resin present in the 2K system.

For the at least one initiator optionally present in the curing agent component, the statements and preferences previously described for the at least one initiator optionally present in the reactive resin apply mutatis mutandis.

The curing agent component contains for example 0.1% to 5% by weight, preferably 0.5% to 3% by weight, of at least one accelerator, in each case based on the total weight of the reactive resin present in the 2K system.

For the at least one accelerator optionally present in the curing agent component, the statements and preferences previously described for the at least one accelerator optionally present in the reactive resin apply mutatis mutandis.

In one embodiment of the present invention, the curing agent component may consist either of the at least one initiator or of the at least one accelerator. In that case, the reactive resin preferably does not contain the component of which the curing agent component consists.

It is additionally possible that the curing agent component, as well as either the at least one initiator or the at least one accelerator, contains further components, for example the dyes and/or fillers and/or auxiliaries and additives mentioned further below. It is preferable in accordance with the invention that the curing agent component is essentially free of ethyl methacrylate.

In accordance with the invention it is preferable that it is the reactive resin in the 2K system that contains the at least one accelerator. In that case, the curing agent component preferably contains the at least one initiator. In this embodiment, the reactive resin preferably does not contain an initiator. In that case, the curing agent component preferably does not contain an accelerator.

It is further preferable that the curing agent component in the 2K system is essentially free of phthalates. It is likewise preferable that the reactive resin in the 2K system is essentially free of phthalates.

Preference is therefore given in accordance with the invention to a 2K system in which the curing agent component and/or the reactive resin is essentially free of phthalates.

Particularly preferably, the 2K system is free of phthalates.

The 2K system may also contain dyes and/or fillers. For example, the 2K system contains in the range from 0% to 90% by weight, preferably in the range from 5% to 50% by weight, of dyes and/or fillers, based on the total weight of the 2K system.

Particularly suitable dyes are, for example, white, red, blue, green and/or yellow inorganic pigments. Particular preference is given to white inorganic pigments such as titanium dioxide.

Fillers are in particular mineral fillers. Mineral fillers are preferably selected from the group consisting of calcium carbonate, barium sulfate, quartz, ground quartz, precipitated silicas, fumed silicas, corundums, glass beads, and cristobalites.

The 2K system may additionally contain auxiliaries and additives. For example, the 2K system contains in the range from 0.1% to 5% by weight of auxiliaries and additives, based on the total weight of the 2K system. Auxiliaries and additives for 2K systems are known per se and are selected for example from the group consisting of chain-transfer agents, plasticizers, paraffins, stabilizers, inhibitors, waxes and/or oils.

Paraffins are for example added in order to prevent inhibition of polymerization by oxygen from the air. It is possible to use for this purpose two or more paraffins having different melting points in different concentrations.

Chain-transfer agents used may be any compounds known from free-radical polymerization. Preference is given to using mercaptans such as n-dodecyl mercaptan, but also polyfunctional mercapto compounds such as pentaerythritol tetrathioglycolate.

Plasticizers used are preferably esters, polyols, oils or low-molecular-weight polyethers.

Useful stabilizers are in particular UV stabilizers. The UV stabilizers are preferably selected from the group consisting of benzophenone derivatives, benzotriazole derivatives, thioxanthonate derivatives, piperidinol carboxylic ester derivatives, and cinnamic ester derivatives.

From the group of inhibitors, preference is given to using substituted phenols, hydroquinone derivatives, phosphines, and phosphites.

For use of the 2K system, the reactive resin and the curing agent component are mixed together. After the reactive resin has been mixed with the curing agent component, the 2K system typically has only a limited remaining open time of, for example, 2 to 40 minutes in which the 2K system may be used for application, pouring, coating or filling, for example. Thereafter, the 2K system typically cures. The term “open time” is in accordance with the invention thus understood as meaning the time interval between the mixing of the reactive resin with the curing agent component and the curing of the 2K system. The open time thus corresponds to the time during which the 2K system is processable. The open time is also referred to as the pot life.

The 2K systems of the invention can be used for example as road markings, as road repair compounds, as a membrane, as a waterproofing, as an intumescent coating, as a floor coating, as a casting resin, as a building protection, as a coating agent and/or as a laminating agent.

The present invention therefore also provides for the use of a 2K system of the invention as a road marking, road repair compound, membrane, waterproofing, intumescent coating, floor coating, casting resin, building protection, coating agent and/or laminating agent.

Road markings in the context of the present invention are understood as meaning all coatings applied to roadways or sidewalks for marking purposes that are not applied just temporarily, for example for short-term marking in a construction site area. This includes in particular also cycle paths, sidewalks and/or runways for air traffic. Floor coatings relate here to further coatings of floor materials such as concrete, asphalt, screed or tar, which are located in particular outdoors. However, it is also possible to coat floor materials in indoor areas.

As a waterproofing, the 2K systems can be used in particular as waterproofing of roofs, bridges, and kitchens and/or of joints thereof.

For example, when used as a membrane, the 2K systems can be used as a vapor barrier membrane, for example on roofs, and/or waterproofing membrane.

As a coating agent or as building protection, the 2K system of the invention can be used in particular as corrosion protection.

When used as an intumescent coating, the 2K system is applied for example as a flame-retardant coating on steel structures.

### EXAMPLES

### Examples 1 to 6

### Production of Reactive Resin

A 2000 ml (milliliters) jacketed glass reactor with reflux condenser and mechanical stirrer (anchor stirrer) was charged with 607 g of the alkyl (meth)acrylatespecified in Tables 1 and 2, 50 g of triethylene glycol dimethacrylate, 323.5 g of Degalan AD 932 (Röhm, copolymer of methyl methacrylate and n-butyl methacrylate with Mw (weight-average molecular weight) of 65 000 g/mol and an acid value of 3.5 mg (KOH)/g), 5.0 g of triisodecyl phosphite, 0.5 g of 2,6-di-tert-butyl-4-methylphenol, 5.0 g of paraffin mixture (melting point 46 to 55° C.), and 9.0 g of N,N-bis(2-hydroxypropyl)-p-toluidine and the mixture was stirred. The jacket was heated with 60° C. warm water until the components had reached a temperature of 55° C. The mixture was stirred until all components had dissolved, then the reactive resin obtained was cooled to 23° C. while stirring.

### Curing at 23° C.

For curing, 100 g of the reactive resin obtained was mixed with 3.0 g of curing agent component in pulverulent form (50% dibenzoyl peroxide, Perkadox GB-50X, from Nouryon) at 23° C. and stirred for 2 min. The mixture was then poured onto a polymethylmethacrylate plate and applied homogeneously with a short-fiber paint roller (mohair, 4 mm fiber height) in the open atmosphere at 23° C. within a 3-minute period to a layer thickness of 300 μm. 60 min after application had been completed, the curing was checked by running a gloved hand across the surface. If curing is incomplete, the surface remains sticky.

Paraffin Film re-Formation/Post-Processability at 23° C. For curing, 100 g of the reactive resin obtained was mixed with 3.0 g of curing agent component in pulverulent form (50% dibenzoyl peroxide, Perkadox GB-50X, from Nouryon) at 23° C. and stirred for 2 min. The mixture was then poured onto a polymethylmethacrylate plate and applied homogeneously with a short-fiber paint roller (mohair, 4 mm fiber height) in the open atmosphere at 23° C. within a 3-minute period to a layer thickness of 300 μm. 120 seconds after application had been completed, the surface of the coating was rollered over once again with the short-fiber paint roller, breaking up the paraffin film that had formed in the meantime. The curing was then checked again 60 min after application of the coating by running a gloved hand across the re-rollered surface. The re-rollered coating was considered post-processable only if it had cured tack-free after 60 min. Because of the limited pot life of the 2K system (the coating compound), two or more mixtures of the coating compound are generally needed to coat a coating surface in practice. In practice, this means that a coating that has been applied once will need to be rollered over/leveled over again during application of the next fresh coating compound in order to achieve a uniform coating. This means it must be possible for the coating compound to undergo post-processing some minutes after being spread on the coating surface.

### Curing at 5° C.

For curing, 100 g of the reactive resin obtained was mixed with 6.0 g of curing agent component in pulverulent form (50% dibenzoyl peroxide, Perkadox GB-50X, from Nouryon) at 5° C. and stirred for 3 min. The mixture was then poured onto a polymethylmethacrylate plate stored at 5° C. and applied homogeneously with a short-fiber paint roller (mohair, 4 mm fiber height) in the open atmosphere at 5° C. within a 3-minute period to a layer thickness of 300 μm. After 60 min, the curing was checked by running a gloved hand across the surface.

The results of the tests described above are shown in Table 1.

TABLE 1

| | | | | Post- |
|---|---|---|---|---|
| | | | | process- |
| | Alkyl | Curing at | Curing at | ability |
| Example | methacrylate | 23° C. | 5° C. | at 23° C. |
| Comparative | Methyl | Tack-free | Tack-free | Yes |
| example 1 | methacrylate | curing | curing | |
| Example 2 | Ethyl | Tack-free | Tack-free | Yes |
| | methacrylate | curing | curing | |
| Comparative | N-Propyl | Tack-free | Incomplete | No |
| example 3 | methacrylate | curing | curing/partially | |
| | | | tacky surface | |
| Comparative | N-Butyl | Incomplete | Incomplete | No |
| example 4 | methacrylate | curing/partially | curing/partially | |
| | | tacky surface | tacky surface | |

The examples in Table 1 show that tack-free curing at low temperatures can be achieved only in the presence of short-chain methacrylates (methyl methacrylate, ethyl methacrylate). Even at 23° C., inadequate post-processability means that the longer-chain alkyl methacrylates (n-propyl methacrylate, n-butyl methacrylate) cannot be laid on practice-relevant surfaces without curing problems, i.e. defects. At the same time, the use of methyl methacrylate results in greater exposure of users and greater odor nuisance.

### Measurement of Viscosity

The viscosity of the reactive resin obtained was determined a Brookfield DV2T viscometer

For determination of the pot life, curing time, and proportions of volatile compounds during curing, for each test at 20° C. from 100 g of the reactive resin obtained was mixed in a 200 ml plastic beaker with 3.0 g of curing agent component in pulverulent form (50% dibenzoyl peroxide, Perkadox GB-50X, from Nouryon) at 23° C. and stirred for 3 min. The 2K system thus obtained was then subjected to the tests.

### Determination of pot Life

The time taken for the 2K system to warm to 32° C. by itself after adding the curing agent component was measured.

### Determination of Curing Time

The 2K system was stirred for 3 min and then poured into a shallow aluminum dish (2 mm layer thickness). The time taken until tack-free curing was determined.

### Determination of Proportion of Volatile Compounds During Curing

The 2K system was stirred for 3 min and then poured into a shallow aluminum dish 5 cm in diameter (layer thickness 1.5 mm) and the initial weight exactly determined on an analytical balance. After 60 min, the loss in weight was determined gravimetrically.

### Determination of Shrinkage During Curing

Before performing the tests, the inner sides of a stainless steel trough 1000 mm in length (cross section equilateral triangle having an edge length of 35 mm) were rubbed with paraffin wax. 500 g of the reactive resin obtained was mixed with 15.0 g of curing agent component in pulverulent form (50% dibenzoyl peroxide, Perkadox GB-50X, from Nouryon) at 23° C. and stirred for 2 min. The stainless steel trough was then filled to the top edge with the 2K system obtained (approx. 230 g). After storage for 7 days, the prism that had formed was removed from the trough and the reduction in linear extent was measured.

### Determination of Dirt Pick-up of Markings

Flame soot and iron (II, III) oxide are rubbed onto the surface of test specimens of the cured coating compounds. The surface is then evenly cleaned of the soiling using water and a sponge until no visually perceptible improvement in soiling occurs. Soiling is assessed visually and in comparison with samples.

The results of the tests described above are shown in Table 2.

TABLE 2

| | | | | | Loss in | Shrinkage |
|---|---|---|---|---|---|---|
| | | | | | weight | after |
| | Alkyl | | | Curing | during | 7 days at |
| Example | methacrylate | Viscosity | Pot life | time | curing | 23° C. |
| Comparative | Methyl | 185 | 7 min | 12 min | 2.9% | 4.95 mm |
| example 5 | methacrylate | mPa · s | | | | |
| Example 6 | Ethyl | 175 | 7.5 min | 14 min | 2.2% | 2.50 mm |
| | methacrylate | mPa · s | | | | |

In the comparison between the alkyl methacrylates, the examples show that ethyl methacrylate and methyl methacrylate result in almost identical properties with regard to resin viscosity, pot life, and curing time. However, when using ethyl methacrylate, a smaller loss in weight/proportion of volatile compounds during curing is measurable and much lower shrinkage after curing is present.

### Examples 7 to 12

### Production of Reactive Resin

A 2000 ml (milliliters) jacketed glass reactor with reflux condenser and mechanical stirrer (anchor stirrer) was charged with 329.70 g of the alkyl (meth)acrylatespecified in Table 3, 335 g of n-butyl acrylate, 20.0 g of triethylene glycol dimethacrylate, 20 g of trimethylolpropane trimethacrylate, 270 g of prepolymer, 0.300 g of 2,6-di-tert-butyl-4-methylphenol, 5.0 g of paraffin wax (melting point from 52 to 54° C.), and 20.0 g of N, N-bis(2-hydroxypropyl)-p-toluidine and the mixture was stirred. The jacket was then heated with 60° C. warm water until the components had reached a temperature of 55° C. The mixture was stirred until all components had dissolved. The reactive resin obtained was then cooled to 23° C. with stirring.

### Formulation of Cold-Spray Plastic (2K System) From Reactive Resin According to Examples 7 to 12

2-component cold-spray plastic compounds were formulated based on the resulting reactive resins, for road marking by way of example, as follows:
Cold-spray plastic formulation:
Reactive resin: 32% by weight
Dispersing additive: 0.2% by weight of Disperbyk 167
Rheology additive: 0.15% by weight of Bentone 27
Pigment: 10% by weight of titanium dioxide
Fine filler: 57.65% by weight of Omyacarb 15GU

The cold plastic compound is intensively mixed with 2% by weight of curing agent component in pulverulent form (50% dibenzoyl peroxide, Perkadox GB-50X, from Nouryon) and applied to a surface at 23° C. using a line marker with a gap width of 1 mm. After one hour, the cured cold-spray plastics are tested in respect of their tendency to soiling.

TABLE 3

| | | | | Comparative | Comparative | Comparative |
|---|---|---|---|---|---|---|
| | | Comparative | | example | example | example |
| | Example 7 | example 8 | Example 9 | 10 | 11 | 12 |
| Alkyl | Ethyl | Ethyl | Ethyl | Ethyl | Methyl | Methyl |
| (meth)acrylate | methacrylate | methacrylate | methacrylate | methacrylate | methacrylate | methacrylate |
| Prepolymer | Degalan LP | Degalan LP | Degalan AD | Degalan PM | Degalan LP | Degalan LP |
| | 64/12 | 66/02 | 932 | 612 | 64/12 | 66/02 |
| Acid value of | 8 mg | 0 mg | 3.5 mg | 14 mg | 8 mg | 0 mg |
| prepolymer | (KOH)/g | (KOH)/g | (KOH)/g | (KOH)/g | (KOH)/g | (KOH)/g |
| Dirt pick-up | Low | Very high | Moderate | High | Low | Low |

Comparative examples 11 and 12 show that, when using methyl methacrylate as monomer, the acid value of the polymer component has no negative effect on the dirt pick-up of the marking. Comparative example 8 shows that, when using ethyl methacrylate as monomer, the dirt pick-up due to the absence of acid in the polymer component results in high dirt pick-up. Comparative example 10 shows that, when using ethyl methacrylate as monomer and a polymer component having a high acid value, high dirt pick-up results. In order to achieve low dirt pick-up in ethyl methacrylate resins, the acid value of the polymer component must be in the range according to the invention.

1. A reactive resin, comprising
5% to 94% by weight of ethyl methacrylate,
5% to 50% by weight of at least one prepolymer having an acid value in a range from 1 to 12 mg (KOH)/g,
0% to 50% by weight of at least one oligomer,
0% to 30% by weight of at least one crosslinker,
0% to 80% by weight of at least one comonomer,
and optionally either 0.1% to 10% by weight of at least one initiator or 0.1% to 5% by weight of at least one accelerator,
in each case based on a total weight of the reactive resin.

2. The reactive resin as claimed in claim 1, the reactive resin comprising:
10% to 70% by weight of ethyl methacrylate,
10% to 40% by weight of at least one prepolymer having an acid value in the range from 1 to 12 mg (KOH)/g,
0% to 50% by weight of at least one oligomer,
0.1% to 15% by weight of at least one crosslinker,
0% to 40% by weight of at least one comonomer,
and optionally either 1% to 5% by weight of at least one initiator or 0.5% to 3% by weight of at least one accelerator,
in each case based on the total weight of the reactive resin.

3. The reactive resin as claimed in claim 1, wherein the at least one prepolymer has a weight-average molecular weight in a range from 25 000 g/mol to 80 000 g/mol.

4. The reactive resin as claimed in claim 1, wherein the at least one prepolymer is selected from the group consisting of polyesters and poly(meth)acrylates.

5. The reactive resin as claimed in claim 1, wherein the at least one oligomer has a weight-average molecular weight in a range from >1000 g/mol to <25 000 g/mol.

6. The reactive resin as claimed in claim 1, wherein the at least one oligomer is selected from the group consisting of polyurethane(meth)acrylates, polyethylene glycol, polypropylene glycol, and polytetrahydrofuran.

7. The reactive resin as claimed in claim 1, wherein the at least one crosslinker has a molecular weight in a range from 150 g/mol to 1000 g/mol.

8. The reactive resin as claimed in claim 1, wherein the at least one crosslinker is selected from the group consisting of difunctional, trifunctional, tetrafunctional, pentafunctional, and hexafunctional (meth)acrylates.

9. The reactive resin as claimed in claim 1, wherein the at least one comonomer is selected from the group consisting of C₃-C₁₈-alkyl (meth)acrylates, C₁-C₂-alkoxy (meth)acrylates, (meth)acrylic acid, itaconic acid, (meth)acrylamide, 1-alkenes, and styrene.

10. The reactive resin as claimed in claim 1, wherein the reactive resin is essentially free of methyl (meth)acrylate .

11. The reactive resin as claimed in claim 1, wherein the at least one initiator is selected from the group consisting of peroxides, azo compounds, and persulfates.

12. The reactive resin as claimed in claim 1, wherein the at least one accelerator is selected from the group consisting of tertiary aromatically substituted amines.

13. A 2K system, comprising
a reactive resin as claimed in claim 1, and
a curing agent component that comprises either 0.1% to 10% by weight of at least one initiator or 0.1% to 5% by weight of at least one accelerator, in each case based on the total weight of the reactive resin, wherein
either the reactive resin contains the at least one initiator and the curing agent component contains the at least one accelerator or
the reactive resin comprises the least one accelerator and the curing agent component comprises the least one initiator.

14. The 2K system as claimed in claim 13, wherein the curing agent component and/or the reactive resin is essentially free of phthalates.

15. A road marking, road repair compound, membrane, waterproofing, intumescent coating, floor coating, casting resin, building protection, coating agent and/or laminating agent comprising the 2K system as claimed in claim 13.
